(19) United States
(12) Patent Application Publication
(10) Pub. No.: US 2016/0250574 A1
(43) Pub. Date: Sep. 1, 2016

(54) FILTER MATERIAL AND FILTER MATERIAL COMBINATION FOR ISOLATING LIQUIDS, AND FILTER ELEMENTS MANUFACTURED THEREFROM

(71) Applicant: Neenah Gessner GmbH, Bruckmühl (DE)

(72) Inventors: Werner HÖRL, Feldkirchen-Westerham (DE); Andreas DEMMEL, Feldkirchen-Westerham (DE); Christoph HÄRINGER, Halblech (DE); Jürgen NIENTIEDT, Großkarolinenfeld (DE)

(21) Appl. No.: 14/910,180

(22) PCT Filed: Jul. 16, 2015
(86) PCT No.: PCT/EP2015/001464

§ 371 Date: Feb. 4, 2016

(30) Foreign Application Priority Data
Aug. 5, 2014 (DE) 10 2014 011 715.4

(51) Int. Cl. B01D 39/16

(52) U.S. Cl. CPC B01D 39/163

(57) ABSTRACT

A filter material for isolating liquids from fluid streams comprises a wetlaid or drylaid non-woven or woven, or an open-cell foam. The two sides of the filter material are impregnated with two different binders in such a way that one side of the filter material has a higher surface energy and thus a shorter drop absorption time than the opposing side.

The invention relates to a filter material for isolating liquids from fluid streams according to the preamble to claim 1, a filter material combination according to the preamble to claim 15, and a filter element according to claim 22.

### PRIOR ART

In many fields, filter systems are used for isolating liquids from fluid streams. For example, when manufacturing compressed air, the air which has been compressed must be freed of oil mist and water mist before it can be further used.

A further use is in isolating liquid droplets from a system comprising two liquids which are not miscible with one another, such as when isolating finely dispersed water droplets from fuels, in particular diesel fuels.

Non-miscible liquids are understood as being liquids of the kind which do not form a homogeneous mixture or solution with one another, but rather form a two-phase mixture, for example oil and water. Within the meaning of the invention, two liquids are considered not to be miscible with one another when, at room temperature (20° C.), at most 10 wt. % of one of the liquids dissolves in the respective other liquid, based on 100 wt. % of the two liquids which are not miscible with one another.

Fluids are to be understood as liquids or gases or mixtures thereof.

Since the droplets of the liquid to be separated out are usually present very finely dispersed in the fluid stream, attempts are usually made to collect the droplets on a suitable filter material by means of adsorption, and at the same time to enlarge said droplets. These enlarged droplets then meet a second filter medium, viewed in the flow direction. Said second filter medium cannot be penetrated by the liquid droplets on account of a corresponding surface energy. The liquid droplets are therefore separated out onto the upstream surface of the second filter material and are usually discharged by means of gravity.

Filter materials for the filtration of fluids are usually impregnated with a binder. The impregnation provides the filter material with a high degree of stiffness and with resistance to aggressive liquids, for example hot engine oil, hydraulic oils, fuels, acids and lyes. Since most filter materials are folded in a further processing step, a high degree of stiffness is required. Stiff filter materials are easier to fold, and the folds withstand the filtration pressure, even at high flow rates and temperatures.

U.S. Pat. No. 3,890,123 A1 describes a filter system for separating liquid droplets out of a gas flow.

EP 1 606 037 A1 discloses a filter system for isolating water from fuel.

The disadvantage of the current filter materials for separating liquids out of fluid streams consists in the fact that they consist of at least two different filter media. The use of at least two layers results in a relatively thick filter material. However, the thicker the filter material is, the smaller the filtering surface in a filter element of a specified size. Moreover, manufacturing filter materials from at least two layers of filter media is complex and cost-intensive.

The object of the present invention is therefore that of providing a filter material for isolating liquids from fluid streams which has a low thickness and is inexpensive to manufacture. In addition, a filter material combination comprising a filter material of this kind, and a filter element manufactured therefrom, are to be provided.

### SUMMARY OF THE INVENTION

This object is achieved according to the invention by the features of claims 1, 15 and 22. Advantageous embodiments of the invention are described in the further claims.

### DETAILED DESCRIPTION OF THE INVENTION

The filter material according to the invention comprises at least one material selected from the group consisting of wetlaid non-wovens, drylaid non-wovens, wovens and open-cell foams, wherein both sides of the filter material are impregnated with two different binders in such a way that the first side of the filter material has a higher surface energy and thus a shorter drop absorption time than the second, opposing side.

The terms “first side” and “second side” are to be understood within the context of the present invention as being independent of the inflow direction of the filter material.

The term “binder” refers either to the binder alone or to the combination of the binder with one or more additives which modify the surface energy.

The filter material according to the invention is planar, i.e. it comprises two opposing sides or surfaces which are preferably arranged so as to be parallel to one another.

Although the measurement of the contact angle is well suited for selecting an appropriate binder, the drop absorption time according to AATCC 18 is preferred when determining the surface energy of an impregnated filter material, on account of the irregular surface thereof.

Within the meaning of this invention, wetlaid non-wovens or papers are all non-wovens which can be produced using wetlaying processes known to experts for manufacturing filter papers. The papers for the filter material according to the invention consist of natural, synthetic, inorganic fibres or a mixture thereof. Examples of natural fibres are cellulose, cotton, wool, hemp, it being possible for the cellulose material used to be wood-free and/or wood-containing celluloses of conifers and/or deciduous trees, regenerated celluloses and fibrillated celluloses. Inorganic fibres are, for example, glass fibres, basalt fibres, quartz fibres and metal fibres. Polyester fibres, polypropylene fibres, multicomponent fibres of which the individual components have different melting points, polyamide fibres and acrylic fibres for example are suitable as synthetic fibres. The titre of the synthetic fibres is typically from 0.1 dtex-8.0 dtex, preferably 0.5 dtex-5 dtex, and the cutting length is typically from 3 mm-20 mm, preferably 4 mm-12 mm. The papers for the filter material according to the invention can consist 100% of natural, synthetic or inorganic fibres, but any desired combination of these kinds of fibres is also possible. A person skilled in the art knows, on account of his knowledge and experience, that the correct composition should be specifically selected in each case according to the required paper properties. The paper layer can consist of a plurality of plies, which are either produced in a paper machine, having a head box suitable for this purpose, and combined, or produced from individual paper webs which are interconnected in a separate processing step. In this case, the individual plies can have different properties.

Drylaid non-wovens are to be understood as, inter alia, drylaid staple fibre non-wovens, meltblown non-wovens and spunlaid non-wovens.

Drylaid staple fibre non-wovens consist of fibres of finite lengths. Both natural and synthetic fibres can be used to manufacture drylaid staple fibre non-wovens. Examples of natural fibres are cellulose, wool, cotton, flax. Synthetic fibres are, for example, polyolefin fibres, polyester fibres, polyamide fibres, polytetrafluoroethylene fibres, polyphenylene sulfide fibres. The fibres used can be either straight or curled. For the purpose of bonding, the airlaid staple fibre non-woven can contain single-component or multicomponent fusible binder fibres which melt, completely or in part, at a temperature below the melting temperature of the other fibres and bond the non-woven. The airlaid staple fibre non-wovens are manufactured in accordance with the known prior art, as described in the book “Vliesstoffe [non-wovens], W. Albrecht, H. Fuchs, Wiley-VCH, 2012”. The drylaid staple fibre non-wovens can be bonded by means of the single-component or multicomponent fusible binder fibres already mentioned. Further bonding possibilities are for example needle punching, needle punching using a water jet, or saturating or spraying the non-woven with liquid binders and subsequently drying them.

Meltblown non-wovens consist of polymer continuous filament fibres. In order to manufacture the meltblown non-wovens for the filter material according to the invention, the meltblown process known by experts is used, as described for example in Van A. Wente, “Superfine Thermoplastic Fibers”, Industrial Engineering Chemistry, Vol. 48, pages 1342-1346. Suitable polymers are, for example, polycarbonate, polyethylene terephthalate, polybutylene terephthalate, polyethylene naphthalate, polybutylene naphthalate, polyamide, polyphenylene sulfide, polyolefin, polyurethane. The fibres can consist of one or more components. The typical fibre diameters are of between 0.5-10 μm, preferably between 0.5-3 μm. Depending on the requirements, additives such as crystallisation promoters or dyes can also be mixed into the polymers. In addition, the meltblown non-wovens can, if required, be compressed using a calendar.

Spunlaid non-wovens also consist of polymer continuous filament fibres, although the fibre diameter thereof is usually significantly greater than that of the meltblown fibres. Spunlaid non-wovens are manufactured in accordance with the spunlaid process known by experts, as described for example in the patent specifications U.S. Pat. No. 4,340,563 A, U.S. Pat. No. 3,802,817 A, U.S. Pat. No. 3,855,046 A and U.S. Pat. No. 3,692,618 A. Polymers suitable for the spunlaid process are for example polyethylene terephthalate, polybutylene terephthalate, polyethylene naphthalate, polybutylene naphthalate, polyamide, polyphenylene sulfide, polyolefin.

Foams are to be understood as meaning all open-cell foams produced from organic polymers. On account of the open-cell structure thereof, said foams are air-permeable and are suitable for a wide range of filtration applications. The manufacture of suitable foams is described by way of example in U.S. Pat. No. 3,171,820A, DE 1504551 A, DE 601435 A and GB 1111928 A.

In this case, the filter material according to the invention is impregnated with various binders in such a way that the two surfaces of said filter material have different surface energies. For example, for isolating water droplets from fuels, the side of the filter material according to the invention which is hit by the flow first in the flow direction has a high surface energy, whereas the surface energy of the opposing side is low.

The term “high” and “low” surface energy is always to be considered in the context of the task of isolation. High surface energy always causes the surface of the filter material according to the invention to be wetted with the liquid which is intended to be separated. Low surface energy, however, prevents wetting of the surface of the filter material according to the invention, and thus preferably functions as a barrier layer through which the liquid to be separated cannot pass. A person skilled in the art knows, on account of his knowledge, that it is necessary to select the correct adjustment of liquid-collecting properties (high surface energy) and liquid-repelling properties (low surface energy) of the filter material according to the invention.

Binders having high surface energy are for example halogen-free and silicone-free polymer dispersions, polyvinyl alcohol, melamine formaldehyde resin, urea-formaldehyde resins, hydrophilic phenolic and epoxy resins, or mixtures thereof. If necessary, said binders can also be mixed with additives which further increase the surface energy, such as tensides. In this case, the dosage is of from 0.01-5 wt. %, preferably 0.01-1 wt. %, based on the dry binder. In this case, additives are preferred which are either insoluble in the fluids used for the filtration, or which cross-link with the binder. Additives of this kind are, for example, non-ionic, anionic, cationic and amphoteric tensides.

Binders having low surface energy are for example halogen-containing and silicone-containing polymer dispersions, polyvinyl chloride resins, polyvinylidene chloride resins, polyvinylidene fluoride resins, silicone resins, phenolic and epoxy resins, or mixtures thereof. If necessary, said binders can also be mixed with additives which further decrease the surface energy, such as halogen-containing tensides, silicone oils, waxes, fluorocarbons and wax emulsions, zirconium salts. In this case, the dosage is of from 0.01-10 wt. %, preferably 0.01-3 wt. %, based on the dry binder. In this case, additives are preferred which are either insoluble in the fluids used for the filtration, or which cross-link with the binder. Additives of this kind are, for example, reactive silicone resins and reactive silicone compounds.

The binders can be present in the form of dispersions (lattices), solutions or powders for example.

Binders having high surface energy have a contact angle of at most 50°, preferably of at most 20°. Binders having low surface energy have a contact angle of at least 60°, preferably of at least 90°.

The drop absorption time of the first side is preferably at most 80%, particularly preferably at most 50% of the drop absorption time of the second side.

One option for manufacturing the filter material according to the invention consists in fully impregnating the filter material throughout with a first binder. In this case, it is irrelevant whether the first binder has high or low surface energy. However, the first binder preferably has a high surface energy. Subsequently, the filter material according to the invention is impregnated on just one side with the second binder, such that the two surfaces of the filter material have different surface energies. The second binder has a surface energy which differs from that of the first binder. Preferably, the second binder has a lower surface energy than the first binder. In the case of filter materials having two different surfaces, a person skilled in the art selects the most suitable surface for the second impregnation on the basis of the demands placed on the filter material according to the invention. Prior to impregnation with the second binder, the first binder can be dried or fused and, if desired, cross-linked. The second binder can then be separately dried or fused and, if desired, cross-linked. However, it is also possible to first impregnate the filter material with both binders and to then dry or fuse and, if desired, cross-link, the two binders at the same time.

The filter material according to the invention has a resin content of preferably from 1-30%, more preferably from 5-20% after full impregnation with the first binder, and an overall resin content of preferably from 2-50%, more preferably from 5-30% after impregnation on one side with the second binder. The overall resin content is the resin content of the first and of the second binder combined.

Suitable methods for fully impregnating the filter material according to the invention with the first binder are, for example, dip impregnation, size-press impregnation, roller application on both sides, spraying on both sides, or powder application on both sides. The second, single-side impregnation of the fully impregnated filter material with the second binder is carried out for example by means of roller application on one side, a roll doctor, spraying or powder application on one side.

The second option for manufacturing the filter material according to the invention consists in impregnation on both sides. In this case, one surface is impregnated with a first binder, and the second surface is impregnated with a second binder. The first binder has a surface energy which is different from that of the second binder. The application of the first and of the second binder is preferably controlled, for example by means of the viscosity of the binder solution or by appropriately adjusting the process parameters, in such a way that at least one of the two binders penetrates the filter material to at least halfway, but at most three-quarters of the way, through the thickness thereof. More preferably, each of the two binders penetrates the filter material to at least halfway, but at most three-quarters of the way, through the thickness thereof. Prior to impregnation with the second binder, the first binder can be dried or fused and, if desired, cross-linked. The second binder can then be separately dried or fused and, if desired, cross-linked. However, it is also possible to dry or fuse and, if desired, cross-link, the two binders at the same time, after the second binder has been applied.

The filter material according to the invention has a resin content of preferably from 1-30%, more preferably from 5-20% after impregnation with the first binder, and an overall resin content of preferably from 2-50%, more preferably from 5-30% after impregnation with the second binder. The overall resin content is the resin content of the first and of the second binder combined.

Suitable methods for the impregnation on both sides are, for example, roller application on both sides, spraying on both sides, application on both sides using a roll doctor, or powder application on both sides.

A preferred embodiment of the filter material according to the invention is a paper consisting of natural fibres, synthetic fibres, inorganic fibres or mixtures thereof, which is impregnated on one side with a first binder such that the first binder penetrates approximately two-thirds of the paper thickness, and on the opposing side with a second binder such that the second binder likewise penetrates approximately two-thirds of the paper thickness. Said filter material has a grammage of from 50 g/m²-400 g/m², preferably of from 100 g/m²-300 g/m², a thickness of from 0.1 mm-2.0 mm, preferably of from 0.5 mm-1.5 mm, an air permeability of from 1 l/m²s-1500 l/m²s, preferably of from 5 l/m²s-800 l/m²s, a porosity of from 50%-90%, preferably of from 60%-80%, a resin content for the first binder of from 1-30%, preferably of from 5-20%, an overall resin content of from 2%-30%, preferably of from 5%-50%, and a drop absorption time measured on one side of at most 80%, preferably of at most 60%, of the drop absorption time measured on the opposing side.

Within the context of the invention, it is also easily possible for the filter material according to the invention to consist of a plurality of layers or plies. Furthermore, it is also possible for one or more layers made of different materials, in particular a non-woven material, to be provided before and/or after the filter material according to the invention.

In this case, a preferred embodiment is a combination of the filter material according to the invention with a meltblown or spunlaid non-woven. The meltblown or spunlaid non-woven has a grammage of from 5 g/m²-300 g/m², preferably of from 10 g/m²-150 g/m², a thickness of from 0.1 mm-3.0 mm, preferably of from 0.1 mm-1.0 mm, and an air permeability of from 5 l/m²s-3000 l/m²s, preferably of from 10 l/m²s-2000 l/m²s. At least some of the fibres of the non-woven preferably comprise polyamide fibres, polyethylene terephthalate fibres, polybutylene terephthalate fibres, multicomponent fibres and mixtures thereof. Preferably, the non-woven is bonded to the side of the filter material according to the invention which has the shorter drop absorption time. However, it is also possible to arrange the non-woven layer on the side having the longer drop absorption time. Depending on the requirements, the non-woven can be compressed using a calendar.

A further preferred embodiment in this case is a combination of the filter material according to the invention with a drylaid staple fibre non-woven. The drylaid staple fibre non-woven has a grammage of from 5 g/m²-300 g/m², preferably of from 50 g/m²-250 g/m², a thickness of from 0.1 mm-3.0 mm, preferably of from 0.3 mm-2.0 mm, and an air permeability of from 5 l/m²s-4000 l/m²s, preferably of from 50 l/m²s-3000 l/m²s. At least some of the fibres of the drylaid staple fibre non-woven preferably comprise cellulose, wool, cotton, polyolef in fibres, polyester fibres, polyamide fibres, polytetrafluoroethylene fibres, polyphenylene sulfide fibres, multicomponent fibres and mixtures thereof. Preferably, the drylaid staple fibre non-woven is bonded to the side of the filter material according to the invention which has the shorter drop absorption time. However, it is also possible to arrange the non-woven layer on the side having the longer drop absorption time.

The individual layers are bonded either by means of an adhesive, or by means of welded joints, or a combination thereof.

Advantageous adhesives have a softening point of over 200° C. In the use according to the specification, the filter material according to the invention is exposed to temperatures of up to 150° C. and high hydrostatic pressures. The adhesive joint should not break in this case. Suitable adhesives for this application are polyurethane adhesives, polyamide adhesives or polyester adhesives. Particularly preferable in this case are polyurethane adhesives which cross-link with the air humidity. The adhesives can be applied as powder or can be melted on by means of anilox rollers or atomising nozzles. The coating weight of the adhesive is typically of between 5-20 g/m², preferably of between 5-10 g/m².

The welded joint can be produced either by means of an ultrasound system or by means of a thermocalendar. In this case, the polymers of the layers to be welded are reflowed either completely or in regions and are welded together. In this case, the welded joints, formed in regions, can be of any geometric shape for example dots, straight lines, curved lines, rhombuses, triangles, etc. The surface area of the welded joints formed in regions is advantageously at most 10% of the overall surface area of the filter material according to the invention.

Adhesion and welding can also be combined as desired.

The filter material according to the invention can be further processed into all common element shapes. Thus, for example, tubes, pockets or pouches can be produced therefrom. Alternatively, said material can be embossed, folded, corrugated in the transverse direction, fluted in the longitudinal direction, etc.

### Testing Methods

Grammage according to DIN EN ISO 536

Thickness according to DIN EN ISO 534

Air permeability according to DIN EN ISO 9237 at 200 Pa pressure difference

The porosity is calculated from the actual density of the filter medium and the average density of the fibres used, according to the following formula:

Porosity=(1−density of filter medium [g/cm³]/density of fibres [g/cm³])*100%

The portion of the binder in a paper (resin content) is calculated according to the following formula:

Resin content in %=(imp. grammage/paper grammage)*100%

in which

imp. grammage=mass of the dry binder per m² of paper

paper grammage=grammage of the impregnated paper

Contact angle

The contact angle denotes the angle formed between the edge of a liquid droplet on the surface of a solid and said surface. The smaller the contact angle, the more strongly the solid is wetted by the liquid. If water is used as the test liquid, the solid is said to be more strongly hydrophilic the smaller the contact angle is. For the measurement according to the present teaching, distilled water was used as the test liquid. The solid body on which the contact angle was measured was a closed, smooth, dry film of the impregnation to be tested, on a glass plate. Both the distilled water and the film of impregnation agent to be tested were stored in the standard atmosphere according to DIN EN ISO 20187 for 24 hours prior to measuring. The measurement was made using a Krüss G1 contact angle measuring instrument. A direct measurement method was used, the implementation of which is described in the operating manual.

Drop absorption time for methanol-water mixtures according to AATCC 118 (American Association of Textile Chemists and Colorists). The volume ratios of methanol and distilled water are selected according to the surface energy of the filter material in such a way that differences in the drop absorption time can be identified between the two sides.

Water separation according to ISO 16332 under the test conditions according to table 1, measured on flat test pieces.

TABLE 1

| | |
|---|---|
| Measuring temperature | 23° C. ± 2° C. |
| Measurement liquid | Commercially available diesel fuel having a |
| | surface tension of 15 mN/m ± 3 mN/m |
| Pressure difference | 0.26 bar |
| between the two apertures | |
| Volume flow rate | 1100 ml/min |
| Inflow | 4.5 ml/cm²min |
| Water metered into diesel | 1500 ppm ± 170 ppm |
| fuel | |
| Average droplet size | 60 μm |

### EXAMPLE 1 (INVENTION)

In accordance with the generally known method for manufacturing paper, a 100% cellulose paper web was produced in a paper machine. In a separate operating step, said paper was impregnated on the wire side (denser side) with a methanolic solution of a hydrophilic resole resin of the designation Prefere 94 3191 P, available from the company Dynea-Erkner, Erkner, and on the opposing side with a methanolic solution of a hydrophobic resole resin Prefere 94 3193, also by the company Dynea-Erkner, Erkner, and subsequently dried. Prior to impregnation, a silicone resin was mixed into the phenol formaldehyde resin 91 3193 in order to reduce the surface energy. The portion of the silicone resin was 0.3 wt. % based on the dry phenol formaldehyde resin 91 3193. The silicone resin is to be of the designation Silres MSE 100, by the company Wacker, Burghausen. The resin content of the first binder was 8% and the overall resin content was 16%.

The grammage, the air permeability, the thickness, the drop absorption time of both sides, and the water separation according to ISO 16332 was determined for this filter material. In order to determine the drop absorption time, a mixture of 40 vol. % methanol and 60 vol. % distilled water was used. When determining the water separation, the flow was directed against the side having the shorter drop absorption time. The result is set out in table 2.

### EXAMPLE 2 (INVENTION)

Example 2 corresponds to example 1 apart from the fact that a meltblown non-woven layer was in addition adhesively bonded to the side having the shorter drop absorption time. The meltblown non-woven had a grammage of 80 g/m², an air permeability of 200 l/m²s, a thickness of 350 μm. The fibres of the meltblown non-woven consisted of polyamide. A reactive, one-component polyurethane adhesive of the type KLEIBERIT PUR 700.7 by the company Klebchemie, Weingarten was used as the adhesive.

The grammage, the air permeability, the thickness, the drop absorption time of both sides of the paper, and the water separation according to ISO 16332 was determined for this filter material. In order to determine the drop absorption time, a mixture of 40 vol. % methanol and 60 vol. % distilled water was used. When determining the water separation, the flow was directed against the side comprising the meltblown non-woven. The result is set out in table 2.

### EXAMPLE 3 (INVENTION)

Example 3 corresponds to example 1 apart from the fact that a meltblown non-woven layer was in addition adhesively bonded to the side having the longer drop absorption time. The meltblown non-woven had a grammage of 80 g/m², an air permeability of 200 l/m²s, a thickness of 350 μm. The fibres of the meltblown non-woven consisted of polyamide. 5 g/m² of a reactive, one-component polyurethane adhesive of the type KLEIBERIT PUR 700.7 by the company Klebchemie, Weingarten was used as the adhesive.

The grammage, the air permeability, the thickness, the drop absorption time of both sides of the paper, and the water separation according to ISO 16332 was determined for this filter material. In order to determine the drop absorption time, a mixture of 40 vol. % methanol and 60 vol. % distilled water was used. When determining the water separation, the flow was directed against the side comprising the meltblown non-woven. The result is set out in table 2.

### EXAMPLE 4 (COMPARATIVE EXAMPLE)

In accordance with the generally known method for manufacturing paper, a 100% cellulose paper web was produced in a paper machine. In a separate operating step, said paper was impregnated with a methanolic solution of a hydrophilic phenol formaldehyde resin Prefere 94 3193, also by the company Dynea-Erkner, Erkner, and subsequently dried. Prior to impregnation, a silicone resin was mixed into the phenol formaldehyde resin 91 3193 in order to reduce the surface energy. The portion of the silicone resin was 0.3 wt. % based on the dry phenol formaldehyde resin Prefere 91 3193. The silicone resin is to be of the designation Silres MSE 100, by the company Wacker, Burghausen. The resin content was 15 %.

The grammage, the air permeability, the thickness, the drop absorption time of both sides, and the water separation according to ISO 16332 was determined for this filter material. In order to determine the drop absorption time, a mixture of 40 vol. % methanol and 60 vol. % distilled water was used. When determining the water separation, the flow was directed against the top side (more open side). The result is set out in table 2.

TABLE 2

| | | | | | | | Example 4 | |
|---|---|---|---|---|---|---|---|---|
| | Example 1 | | Example 2 | | Example 3 | | (comparative | |
| | (invention) | | (invention) | | (invention) | | example) | |
| Grammage | 245 | g/m² | 332 | g/m² | 332 | g/m² | 243 | g/m² |
| according to | | | | | | | | |
| DIN EN ISO | | | | | | | | |
| 536 | | | | | | | | |
| Air | 9.5 | l/m²s | 10.0 | l/m²s | 10.3 | l/m²s | 9.0 | l/m²s |
| permeability | | | | | | | | |
| according to | | | | | | | | |
| DIN EN ISO | | | | | | | | |
| 9237 | | | | | | | | |
| Thickness | 0.5 | mm | 0.74 | mm | 0.74 | mm | 0.5 | mm |
| according to | | | | | | | | |
| DIN EN ISO | | | | | | | | |
| 534 | | | | | | | | |
| Drop | 48 | s | 48 | s | 48 | s | 127 | s |
| absorption | | | | | | | | |
| time of the | | | | | | | | |
| wire side | | | | | | | | |
| according | | | | | | | | |
| to AATCC 118 | | | | | | | | |
| Drop | 119 | s | 119 | s | 119 | s | 123 | s |
| absorption | | | | | | | | |
| time of the top | | | | | | | | |
| side according | | | | | | | | |
| to AATCC 118 | | | | | | | | |

| | | | | |
|---|---|---|---|---|
| Water | 80% | 100% | 90% | 52% |
| separation | | | | |
| according to | | | | |
| ISO 16332 | | | | |

It can be clearly seen from the results that a significant improvement in water separation is achieved using the filter material according to the invention in example 1 compared with the comparative example. The water separation can be significantly improved again by combining the filter material according to the invention from example 1 with a meltblown non-woven (example 2 and 3).

1. Filter material for isolating liquids from fluid streams, comprising a wetlaid or drylaid non-woven, woven or open-cell foam, the filter material having a first side and a second, opposing side, wherein the two opposing sides of the filter material are impregnated with two different binders in such a way that the first side of the filter material has a higher surface energy and thus a shorter drop absorption time than the second, opposing side.

2. Filter material according to claim 1, wherein the drop absorption time of the first side is at most 80% of the drop absorption time of the second side.

3. Filter material according to claim 1, wherein the drop absorption time of the first side is at most 50% of the drop absorption time of the second side.

4. Filter material according to claim 1, wherein at least one of the two different binders penetrates the filter material to at least halfway and at most three-quarters of the way through the thickness thereof.

5. Filter material according to claim 1, wherein each of the two different binders penetrates the filter material to at least halfway and at most three-quarters of the way through the thickness thereof.

6. Filter material according to claim 1, wherein at least one of the two different binders fully penetrates the filter material.

7. Filter material according to claim 1, wherein the binder of the first side of the filter material having the shorter drop absorption time comprises a halogen-free and silicone-free polymer dispersion, a polyvinyl alcohol, a melamine formaldehyde resin, a urea-formaldehyde resin, a hydrophilic phenolic resin, a hydrophilic epoxy resin, or a mixture thereof.

8. Filter material according to claim 7, wherein the binder contains at least 0.01-5 wt. % of an additive for increasing the surface energy.

9. Filter material according to claim 8, wherein the additive can be cross-linked with the binder of the first side.

10. Filter material according to claim 8, wherein the additive is insoluble in the fluids used for the filtration.

11. Filter material according to claim 1, wherein the binder of the second side of the filter material having the longer drop absorption time and thus the lower surface energy comprises a halogen-containing polymer dispersion, a silicone-containing polymer dispersion, a polyvinyl chloride resin, a polyvinylidene chloride resin, a polyvinylidene fluoride resin, a silicone resin, a phenolic resin, an epoxy resin, or a mixture thereof.

12. Filter material according to claim 11, wherein the binder of the second side contains from 0.01-10 wt. % of an additive for reducing the surface energy.

13. Filter material according to claim 12, wherein the additive can be cross-linked with the binder of the second side.

14. Filter material according to claim 12, wherein the additive is insoluble in the fluids used for the filtration.

15. Filter material combination comprising a filter material according to claim 1, wherein at least one side of the filter material has a further non-woven layer.

16. Filter material combination according to claim 15, wherein the further non-woven layer comprises a meltblown non-woven or a spunlaid non-woven.

17. Filter material combination according to claim 16, wherein the meltblown or spunlaid non-woven has a grammage of from 10 g/m²-150 g/m², a thickness of from 0.1 mm-1.0 mm, and an air permeability of from 10 l/m²s-2000 l/m²s.

18. Filter material combination according to claim 15, wherein the further non-woven layer comprises a drylaid staple fibre non-woven.

19. Filter material combination according to claim 18, wherein the drylaid staple fibre non-woven has a grammage of from 50 g/m²-250 g/m², a thickness of from 0.3 mm-2.0 mm, and an air permeability of from 50 l/m²s-3000 l/m²s.

20. Filter material combination according to claim 15, wherein the further non-woven layer is on the side having the longer drop absorption time.

21. Filter material combination according to claim 15, wherein the further non-woven layer is on the side having the shorter drop absorption time.

22. Filter element comprising a filter material according to claim 1 or a filter material combination comprising a filter material according to claim 1, wherein at least one side of the filter material has a further non-woven layer.
